(19) United States
(12) Patent Application Publication
(10) Pub. No.: US 2026/0311343 A1
(43) Pub. Date: Oct. 8, 2026

(54) METHODS FOR NON-CONTACT MONITORING OF THREE-DIMENSIONAL GLOBAL LANDSLIDE DEFORMATION WITH MILLIMETER-LEVEL ACCURACY

(71) Applicant: SICHUAN UNIVERSITY, Chengdu (CN)

(72) Inventors: Jiawen ZHOU, Chengdu (CN); Haibo LI, Chengdu (CN); Nan JIANG, Chengdu (CN); Xingguo YANG, Chengdu (CN); Yuxiang HU, Chengdu (CN); Xianglong LUO, Chengdu (CN); Gongda LU, Chengdu (CN); Gang FAN, Chengdu (CN); Shunchao QI, Chengdu (CN); Hongyu LUO, Chengdu (CN)

(73) Assignee: SICHUAN UNIVERSITY, Chengdu, (CN)

(21) Appl. No.: 19/457,314

(22) Filed: Jan. 23, 2026

(30) Foreign Application Priority Data
Mar. 31, 2025 (CN) 202510392210.8

(51) Int. Cl. G06T 7/246; G01C 15/00; G06T 7/33; G08B 21/10

(52) U.S. Cl. CPC G06T 7/246; G01C 15/00; G06T 7/33; G08B 21/10; G06T 2207/10028; G06T 2207/10032; G06T 2207/20016; G06T 2207/20021; G06T 2207/20081; G06T 2207/20084; G06T 2207/30181; G06T 2207/30232

(57) ABSTRACT

Provided is a method for non-contact monitoring of three-dimensional global landslide deformation with millimeter-level accuracy, comprising: acquiring two phases of three-dimensional surface deformation point cloud data, and extracting global point cloud features; performing optimization to obtain optimal key registration parameters; obtaining initial calculation points, dividing an initial point cloud block, and performing preliminary registration to obtain an initial transformation matrix; reducing a calculation point spacing to obtain new calculation points, and obtaining initial transformation parameters; rotating and translating the initial point cloud block to a new position, performing re-registration to obtain a new transformation matrix; if a displacement of the new calculation points is less than a specified threshold, determining that calculation of a block region where the new calculation points are located is completed, and gradually reducing the calculation point spacing until the calculation point spacing reaches a minimum value, thereby determining that overall calculation is completed.

### CROSS-REFERENCE TO RELATED APPLICATIONS

This application claims priority to Chinese Patent Application No. 202510392210.8, filed on Mar. 31, 2025, the contents of which are hereby incorporated by reference.

### TECHNICAL FIELD

The present disclosure relates to a field of three-dimensional point cloud technology, in particular to a method for non-contact monitoring of three-dimensional global landslide deformation with millimeter-level accuracy.

### BACKGROUND

A large-scale three-dimensional (3D) surface point cloud data set can be obtained through a 3D laser scanner, airborne light detection and ranging (LiDAR), or unmanned aerial vehicle (UAV) aerial survey. Deformation analysis of a target region can be performed based on two phases of 3D surface point cloud data sets. Traditional approaches of 3D point cloud analysis include a shortest distance manner, a vertical distance manner, an M3C2 manner, etc.

Advantages of the vertical distance manner and the shortest distance manner lie in relatively simple operation and short calculation time, which facilitates quick acquisition of general deformation of a landslide. However, the vertical distance manner cannot reflect deformation of the landslide along a horizontal direction. The shortest distance manner has relatively high randomness. A nearest point found by the algorithm may be relatively far from an actual corresponding point before and after landslide change. The M3C2 manner can obtain a deformation amount of calculation points along a normal direction by fitting a plane. Applicability and accuracy of the M3C2 manner are better than those of the shortest distance manner. However, this approach cannot reflect the displacement of the calculation points along a slope surface direction. In some landslides with a significant amount of sliding along the slope surface, the calculation result of the M3C2 manner may have a relatively large error.

An average domain vector algorithm is a point cloud deformation calculation manner based on an iterative closest point (ICP) algorithm. The ICP algorithm is a point cloud registration algorithm. The average domain vector algorithm has high accuracy when processing point clouds with local uniform deformation. However, in large-area deformation analysis, the average domain vector algorithm has many limitations, such as difficulty in refining deformation analysis results. When the selected local analysis region is too large, boundaries of a deformation region may be unclear, and a calculated deformation value may have a relatively large difference from a real deformation value. When the selected local analysis region is too small, the algorithm is prone to fall into local optimum, resulting in an incorrect deformation value. Meanwhile, the algorithm relies on manual work, which is time-consuming and labor-intensive. Selecting an analysis region requires manual delineation, making it difficult to complete deformation calculation for a large region. In addition, calculation parameters require manual debugging. Unreasonable calculation parameters may cause a relatively large error in calculation results. Multiple trials and errors are often required to obtain relatively reasonable calculation parameters.

Therefore, it is desirable to provide a method for non-contact monitoring of three-dimensional global landslide deformation with millimeter-level accuracy. The method can improve accuracy, avoid local optimum, reduce labor costs, and achieve rapid acquisition of a millimeter-level global deformation field over a large area.

### SUMMARY

One or more embodiments of the present disclosure provide a method for non-contact monitoring of three-dimensional global landslide deformation with millimeter-level accuracy, comprising: S1: acquiring two phases of three-dimensional surface deformation point cloud data for deformation interpretation, and extracting global point cloud features; S2: performing optimization using a Bayesian optimization algorithm based on the global point cloud features and a trained neural network model to obtain an optimal initial calculation point spacing, a minimum point cloud search radius, a maximum correspondence point search distance, a point count threshold of point cloud, and a root mean square error (RMSE) threshold; S3: obtaining initial calculation points based on the optimal initial calculation point spacing, dividing to obtain initial point cloud blocks, performing preliminary registration using an average domain vector algorithm to obtain an initial transformation matrix, and decomposing the initial transformation matrix to obtain a translation vector and a rotation matrix; S4: reducing a calculation point spacing to obtain new calculation points, and performing weighted averaging on a rotation vector and the translation vector of previous calculation points adjacent to the new calculation point using inverse distance weighting (IDW) to obtain initial transformation parameters of the new calculation points; S5: rotating and translating the initial point cloud blocks to new positions based on the initial transformation parameters of the new calculation points, performing re-registration to obtain a new transformation matrix, and decomposing the new transformation matrix to obtain a new translation vector and a new rotation matrix; S6: repeating the S4 and S5, when a displacement of a current calculation point after certain registration is less than a specified threshold, assuming that a current calculation point spacing is d, determining calculation as completed when the displacement of the current calculation point is within a range of d/2, and when reducing the calculation point spacing next time, a region where the calculation point is located not taking the new calculation points but directly using the previous calculation points; and when the calculation point spacing is reduced to the specified threshold, determining calculation as completed after the current calculation ends; after the S6, the method further comprises: interpreting to obtain a translation vector \vec{t}ⁿ corresponding to the calculation points based on all calculation points and corresponding transformation matrices in final calculation, and superimposing the translation vector \vec{t}ⁿ with an initial translation vector \vec{t}ⁿ⁻¹ of the current calculation to obtain a total translation vector \vec{t}^{total} of the calculation points; \vec{t}^{total}=\vec{t}ⁿ⁻¹+\vec{t}ⁿ obtaining a global displacement and deformation field of a calculation region.

One or more embodiments of the present disclosure provide a system for non-contact monitoring of three-dimensional global landslide deformation with millimeter-level accuracy, wherein the system is applied to the method according to any one of claim 1, and the system comprises: a point cloud data acquisition and feature extraction module configured to acquire two phases of three-dimensional surface deformation point cloud data for deformation interpretation and extract global point cloud features; a parameter optimization module configured to perform optimization based on the global point cloud features and a trained neural network model using a Bayesian optimization algorithm to obtain an optimal initial calculation point spacing, a minimum point cloud search radius, a maximum correspondence point search distance, a point count threshold of point cloud, and an RMSE threshold; an initial calculation and registration module configured to obtain initial calculation points based on the optimal initial calculation point spacing, divide to obtain initial point cloud blocks, perform preliminary registration using an average domain vector algorithm to obtain an initial transformation matrix, and decompose the initial transformation matrix to obtain a translation vector and a rotation matrix; a calculation point refinement and weighted average module configured to reduce a calculation point spacing to obtain new calculation points, and perform weighted averaging on a rotation vector and the translation vector of previous calculation points adjacent to the new calculation point using inverse distance weighting to obtain initial transformation parameters of the new calculation points; a point cloud block transformation and re-registration module configured to rotate and translate the initial point cloud blocks to new positions based on the initial transformation parameters of the new calculation points, perform re-registration to obtain a new transformation matrix, and decompose the new transformation matrix to obtain a new translation vector and a new rotation matrix; a convergence determination and calculation control module, wherein when a displacement of a current calculation point after certain registration is less than a specified threshold, assuming that a current calculation point spacing is d, calculation is determined as completed when the displacement of the current calculation point is within a range of d/2, and when reducing the calculation point spacing next time, a region where the calculation point is located does not take the new calculation points but directly uses the previous calculation points; and when the calculation point spacing is reduced to the specified threshold, calculation is determined as completed after the current calculation ends; a final deformation calculation module configured to interpret to obtain translation vectors corresponding to the calculation points based on all calculation points and corresponding transformation matrices in final calculation, superimpose the translation vectors with initial translation vectors of the current calculation to obtain total translation vectors of the calculation points; and obtain a global displacement deformation field of a calculation region.

One or more embodiments of the present disclosure provide a computer device, comprising a memory, a processor, and computer programs stored on the memory and executable on the processor, wherein when executing the programs, the processor implements the method for non-contact monitoring of three-dimensional global landslide deformation with millimeter-level accuracy.

One or more embodiments of the present disclosure provide a non-transitory computer-readable storage medium, comprising computer programs that, when executed by the processor, direct the processor to implement the method for non-contact monitoring of three-dimensional global landslide deformation with millimeter-level accuracy.

Compared with the prior art, the advantages of the present disclosure include:

### 1. High-Accuracy Three-Dimensional Deformation Interpretation:

By gradually reducing the calculation point spacing, deformation interpretation from coarse to fine is achieved, improving accuracy of final interpretation results.

Using the average domain vector algorithm for point cloud block registration reduces influence of local noise and ensures stability and accuracy of point cloud matching.

Through iterative optimization and deformation amount superposition, continuity of the point cloud is fully considered, making calculation results smoother and more reasonable.

### 2. Adaptive Parameter Optimization, Improving Calculation Efficiency:

Combining a neural network model with a Bayesian optimization algorithm automatically optimizes key parameters (e.g., a search radius, a point count threshold, an RMSE threshold, or the like), avoiding manual empirical settings, and improving the intelligent level of calculation.

By training with a large amount of experimental data, calculation parameters can be dynamically adjusted according to different point cloud features (e.g., density, size, deformation amount, terrain type, or the like), making the algorithm applicable to various terrains and data acquisition approaches.

### 3. Scientific Calculation Point Initialization Method, Improving Stability:

Using IDW to estimate initial deformation amounts of new calculation points gives the calculation points good smoothness and continuity during an iterative process, avoiding influence of local outliers.

Through weighted interpolation of deformation information of neighboring points, interference of noise during the registration process is effectively reduced, improving stability of deformation interpretation.

### 4. Reasonable Calculation Termination Mechanism, Reducing Redundant Calculation:

### Set Dual Termination Conditions:

When the calculation point spacing is reduced to a minimum threshold, waste of computing resources is avoided.

When the spacing is reduced to a specified threshold or a deformation amount is less than a set threshold, calculation for a current region is stopped, improving calculation efficiency.

A region-adaptive termination strategy is adopted so that a region that has stably converged is no longer repeatedly calculated, further reducing the calculation burden and improving overall interpretation efficiency.

### 5. Deformation Field Construction is Complete and Suitable for Multiple Applications:

Based on deformation data of final calculation points, a global surface displacement and deformation field is reconstructed, which can be used in fields such as geological disaster monitoring, engineering deformation monitoring, etc.

The method is applicable to a plurality of point cloud data sources (e.g., LiDAR, photogrammetry, UAV point clouds, etc.) and has strong generalization capability.

### BRIEF DESCRIPTION OF THE DRAWINGS

The present disclosure is further described by way of exemplary embodiments. The exemplary embodiments are described in detail with reference to the accompanying drawings. The embodiments are not limiting. In the embodiments, the same reference numerals denote the same structures, wherein:

FIG. 1 is a block diagram illustrating a system for non-contact monitoring of three-dimensional global landslide deformation with millimeter-level accuracy according to some embodiments of the present disclosure;

FIG. 2 is a flowchart illustrating an exemplary method for non-contact monitoring of three-dimensional global landslide deformation with millimeter-level accuracy according to some embodiments of the present disclosure;

FIG. 3 is a schematic diagram illustrating an exemplary process of stepwise calculation according to some embodiments of the present disclosure;

FIG. 4 is a schematic diagram illustrating an exemplary process of network training according to some embodiments of the present disclosure;

FIG. 5 is a schematic diagram illustrating exemplary results of interpreting a deformation field of a quarry slope according to some embodiments of the present disclosure.

### DETAILED DESCRIPTION

It should be noted that the structures, proportions, sizes, or the like illustrated in the present disclosure are merely used to cooperate with the content disclosed in the present disclosure for understanding and reading by those skilled in the art. The structures, proportions, sizes, or the like are not intended to limit the conditions under which the present disclosure can be implemented. Any modification of the structure, change of the proportional relationship, or adjustment of the size, without affecting the effects that can be produced and the objectives that can be achieved by the present disclosure, should still fall within the scope covered by the technical content disclosed in the present disclosure.

Meanwhile, terms such as “upper”, “lower”, “left”, “right”, “middle”, and “a” quoted in the present disclosure are also merely for clarity of description and are not intended to limit the scope of implementation of the present disclosure. Changes or adjustments of the relative relationships, without substantially changing the technical content, should also be considered within the scope of implementation of the present disclosure.

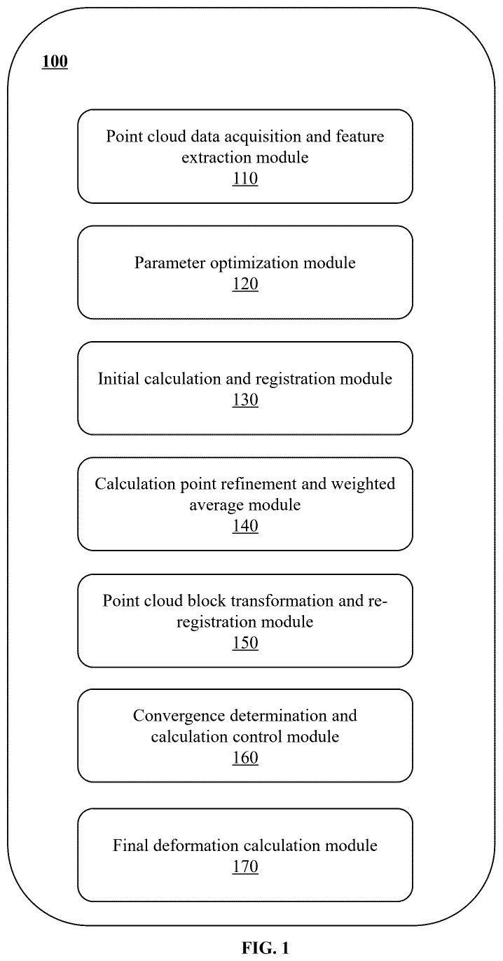

FIG. 1 is a block diagram illustrating a system for non-contact monitoring of three-dimensional global landslide deformation with millimeter-level accuracy according to some embodiments of the present disclosure.

In some embodiments, as shown in FIG. 1, a system 100 for non-contact monitoring of three-dimensional global landslide deformation with millimeter-level accuracy may comprise a point cloud data acquisition and feature extraction module 110, a parameter optimization module 120, an initial calculation and registration module 130, a calculation point refinement and weighted average module 140, a point cloud block transformation and re-registration module 150, a convergence determination and calculation control module 160, and a final deformation calculation module 170.

In some embodiments, the point cloud data acquisition and feature extraction module 110 may be configured to acquire two phases of three-dimensional surface deformation point cloud data for deformation interpretation, and extract global point cloud features.

In some embodiments, the parameter optimization module 120 may be configured to perform optimization using a Bayesian optimization algorithm based on the global point cloud features and a trained neural network model to obtain an optimal initial calculation point spacing, a minimum point cloud search radius, a maximum correspondence point search distance, a point count threshold of point cloud, and a root mean square error (RMSE) threshold.

In some embodiments, the initial calculation and registration module 130 may be configured to obtain initial calculation points based on the optimal initial calculation point spacing, divide to obtain initial point cloud blocks, perform preliminary registration using an average domain vector algorithm to obtain an initial transformation matrix, and decompose the initial transformation matrix to obtain a translation vector and a rotation matrix.

In some embodiments, the calculation point refinement and weighted average module 140 may be configured to reduce a calculation point spacing to obtain new calculation points, and perform weighted averaging on a rotation vector and the translation vector of previous calculation points adjacent to the new calculation point using inverse distance weighting (IDW) to obtain initial transformation parameters of the new calculation points.

In some embodiments, the point cloud block transformation and re-registration module 150 may be configured to rotate and translate the initial point cloud blocks to new positions based on the initial transformation parameters of the new calculation points, perform re-registration to obtain a new transformation matrix, and decompose the new transformation matrix to obtain a new translation vector and a new rotation matrix.

In some embodiments, the convergence determination and calculation control module 160 may be configured such that when a displacement of a current calculation point after certain registration is less than a specified threshold, assuming that a current calculation point spacing is d, calculation is determined as completed when the displacement of the current calculation point is within a range of d/2, and when reducing the calculation point spacing next time, a region where the calculation point is located does not take the new calculation points but directly uses the previous calculation points; and when the calculation point spacing is reduced to the specified threshold, calculation is determined as completed after the current calculation ends.

In some embodiments, the final deformation calculation module 170 may be configured to interpret to obtain translation vectors corresponding to the calculation points based on all calculation points and corresponding transformation matrices in final calculation, superimpose the translation vectors with initial translation vectors of the current calculation to obtain total translation vectors of the calculation points; and obtain a global displacement deformation field of a calculation region.

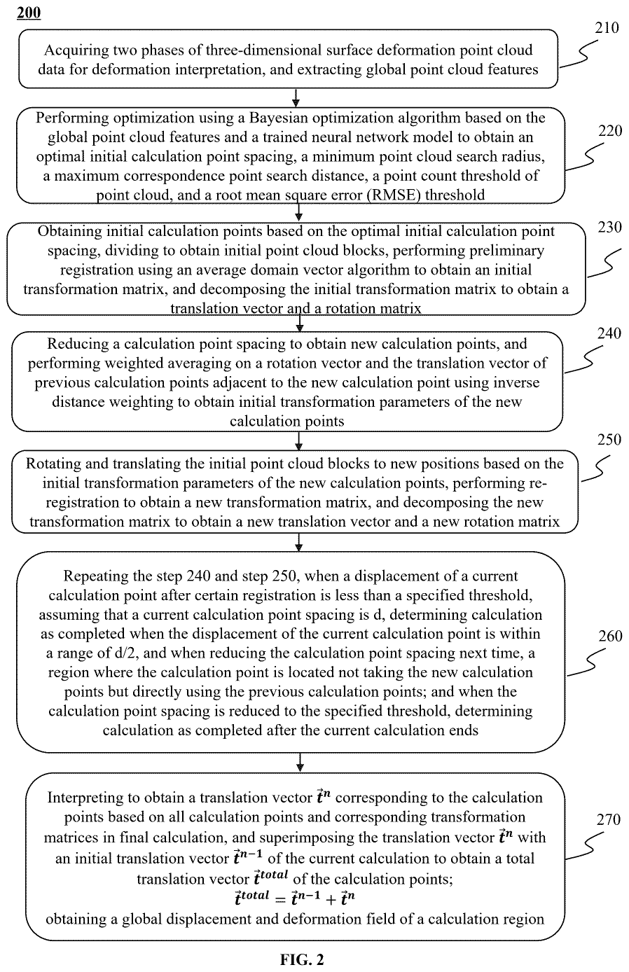

FIG. 2 is a flowchart illustrating an exemplary method for non-contact monitoring of three-dimensional global landslide deformation with millimeter-level accuracy according to some embodiments of the present disclosure.

In some embodiments, as shown in FIG. 2, a process 200 may be executed by a processor. The process 200 may include step 210 to step 260.

In some embodiments, the processor may be integrated into one or more modules of the system 100 for non-contact monitoring of three-dimensional global landslide deformation with millimeter-level accuracy. Alternatively, the processor may be independent of the system 100 for non-contact monitoring of three-dimensional global landslide deformation with millimeter-level accuracy.

In 210, acquiring two phases of three-dimensional surface deformation point cloud data for deformation interpretation, and extracting global point cloud features.

Two phases refer to different times for acquiring the three-dimensional surface deformation point cloud data for the same region. For example, a phase closer to a current moment of the two phases may be referred to as a current phase, and a phase farther from the current moment of the two phases may be referred to as another phase.

The deformation interpretation refers to a process of calculating and extracting three-dimensional displacement and rotation amounts of a surface in three-dimensional space from two phases of three-dimensional point cloud data by a point cloud registration technology.

The three-dimensional surface deformation point cloud data refers to point cloud data reflecting a spatial morphology of the surface.

In some embodiments, the processor may perform the deformation interpretation based on the three-dimensional surface deformation point cloud data of the same region at different times.

In some embodiments, the processor may acquire the three-dimensional surface deformation point cloud data through a three-dimensional laser scanning device. The three-dimensional laser scanning device may include a terrestrial laser scanner, a UAV, an optical satellite, or the like.

The global point cloud features refer to global features in the three-dimensional surface deformation point cloud data.

For example, the global point cloud features may include an average density of point cloud, a size of point cloud, an average deformation estimation value, a terrain type, a point cloud acquisition manner, a smoothness degree of point cloud, or the like.

In some embodiments, the processor may extract the global point cloud features based on the three-dimensional surface deformation point cloud data in various ways.

For example, the processor may obtain the smoothness degree of point cloud based on the three-dimensional surface deformation point cloud data through a PointNet network or curvature calculation based on neighborhood features.

As another example, the processor may use a ratio of a total count of points in the three-dimensional surface deformation point cloud data to a convex hull volume as the average density of point cloud.

In 220, performing optimization using a Bayesian optimization algorithm based on the global point cloud features and a trained neural network model to obtain an optimal initial calculation point spacing, a minimum point cloud search radius, a maximum correspondence point search distance, a point count threshold of point cloud, and a root mean square error (RMSE) threshold.

The trained neural network model refers to a model for obtaining key registration parameters. The key registration parameters may include an initial calculation point spacing, the minimum point cloud search radius, the maximum correspondence point search distance, the point count threshold of point cloud, and the RMSE threshold.

The initial calculation point spacing refers to a planar interval distance of calculation center points arranged within a range of the three-dimensional surface deformation point cloud data during a first division. The calculation center points may also be referred to as calculation points. In some embodiments, the initial calculation point spacing may represent a granularity of the first division of the three-dimensional surface deformation point cloud data.

The minimum point cloud search radius refers to a spatial radius used for dividing blocks.

The maximum correspondence point search distance refers to a parameter for determining whether correspondence point registration fails. For example, the maximum correspondence point search distance may be a maximum Euclidean distance for searching for a correspondence point in a point cloud block of another phase based on a point cloud block of the current phase during registration.

In some embodiments, if a Euclidean distance between the correspondence point in the point cloud block of another phase and a point in the point cloud block of the current phase is greater than the maximum correspondence point search distance, the correspondence point in the point cloud block of another phase is considered to have a failed correspondence with the point in the point cloud block of the current phase.

The point count threshold of point cloud refers to a parameter for limiting a count of points required to constitute a valid block.

The RMSE threshold refers to an accuracy parameter for determining whether block registration is successful.

In some embodiments, the trained neural network model may be a machine learning model. For example, the trained neural network model may be a convolutional neural network (CNN).

In some embodiments, an input of the trained neural network model may include the global point cloud features, and an output of the trained neural network model may include the key registration parameters.

In some embodiments, the neural network model may be obtained by training based on a plurality sets of training samples with training labels. A set of training samples may include sample three-dimensional surface deformation point cloud data. A training label corresponding to the set of training samples may be optimal key registration parameters corresponding to the sample three-dimensional surface deformation point cloud data.

In some embodiments, the processor may determine historical global point cloud features based on two phases of three-dimensional surface deformation point cloud data acquired by the three-dimensional laser scanning device in historical experiments, and determine the historical global point cloud features as the training samples. In some embodiments, the processor may perform a grid search on the key registration parameters, register each set of key registration parameters after performing the grid search with the two phases of three-dimensional surface deformation point cloud data corresponding to the historical global point cloud features, obtain a loss value after registration for each set of key registration parameters, and determine a set of key registration parameters with a minimum loss value as a training label corresponding to the historical global point cloud features. More descriptions regarding determining the loss value may be found in the related descriptions of the step 220 in FIG. 2.

The grid search refers to a process of traversing all parameter combinations within a multi-dimensional continuous interval (e.g., if the key registration parameters include five dimensions, the multi-dimensional continuous interval may be a five-dimensional continuous interval). The registration refers to an operation process of overlapping the two phases of three-dimensional surface deformation point cloud data to calculate surface displacement and rotation.

In some embodiments, the processor may perform multiple iterative trainings on an initial neural network model based on the plurality sets of training samples with the training labels until an iteration termination condition is satisfied to obtain the trained neural network model. At least one iterative training includes: inputting one or more sets of training samples into the initial neural network model to obtain model outputs corresponding to the one or more sets of training samples; substituting the model outputs corresponding to the one or more sets of training samples and the training labels corresponding to the one or more sets of training samples into a formula of a predefined loss function to calculate a value of the loss function; and iteratively updating model parameters of the initial neural network model according to the value of the loss function until the iteration termination condition is satisfied to end the iteration, thereby obtaining the trained neural network model. The iterative updating of the model parameters of the initial neural network model may be performed in various ways. For example, the updating may be performed based on gradient descent. The iteration termination condition may include convergence of the loss function, an iteration count reaching an iteration count threshold, a value of the loss function being less than a preset function value threshold, etc.

In some embodiments, data for training of the neural network model may include the global point cloud features, calculation parameters, a point RMSE corresponding to a registration result, and a proportion of successfully matched blocks; a loss function considering an RMSE of the registration results and the proportion of successfully matched blocks, a calculation formula of the loss function being expressed as:

$$loss = α RMSE + β P + γ$$

where loss represents a loss value; RMSE represents an average RMSE of all block matching results; represents the proportion of successfully matched blocks; α, β and γ represent hyperparameters, respectively; for the average RMSE of all block matching results, the average RMSE is calculated by:

$$RMSE = \frac{{\sum }_{i = 1}^{{n}^{S}} {RMSE}_{i}}{{n}^{S}}$$

where n^{s} represents a total count of successfully registered blocks; i represents an i-th block; RMSE; represents an RMSE of a corresponding point pair after registration of the i-th block, calculation of RMSEᵢ is expressed as:

$${RMSE}_{i} = \sqrt{\frac{{\sum }_{j = 1}^{{n}_{i}} ( ( {x}_{j}^{a} - {x}_{j}^{b} ) + ( {y}_{j}^{a} - {y}_{j}^{b} ) + ( {z}_{j}^{a} - {z}_{j}^{b} ) )}{{n}_{i}}}$$

where nᵢ represents a count of points contained in an i-th block; xⱼ^{a}, yⱼ^{a} and zⱼ^{a} represent coordinates of a j-th point in the i-th block; xⱼ^{b}, yⱼ^{b}, and zⱼ^{b} represent coordinates of a matching point of the j-th point in the i-th block in another phase of block; for the proportion P of successfully matched blocks, calculation of the proportion of successfully matched blocks being expressed as:

$$P = \frac{{n}^{S}}{n}$$

where n^{s} represents the total count of successfully registered blocks, and n represents a total count of blocks.

The calculation parameters may also be referred to as the key registration parameters. More descriptions regarding the key registration parameters may be found in the related descriptions above.

The point RMSE corresponding to the registration result refers to an index for quantifying registration accuracy of blocks between the two phases of three-dimensional surface deformation point cloud data. For example, the point RMSE corresponding to the registration result may be an average value of RMSEs between blocks of the three-dimensional surface deformation point cloud data of the current phase and blocks of the three-dimensional surface deformation point cloud data of another phase. The smaller the RMSE, the higher the registration alignment accuracy of all point cloud blocks.

The block refers to partial data after division of the three-dimensional surface deformation point cloud data.

In some embodiments, the processor may determine the block based on the three-dimensional surface deformation point cloud data and the key registration parameters. For example, the processor may lay out center points based on the initial calculation point spacing, and delineate a search range corresponding to each center point with the minimum point cloud search radius. When a count of points in the three-dimensional surface deformation point cloud data within the search range is not less than the point count threshold of point cloud, the range and points within the range are determined as a block.

In some embodiments, the processor may determine an average value of RMSEs of all corresponding point cloud blocks, i.e., the point RMSE corresponding to the registration result, based on the RMSEs between the blocks of the three-dimensional surface deformation point cloud data of the current phase and the blocks of the three-dimensional surface deformation point cloud data of another phase.

The proportion of successfully matched blocks refers to an index for evaluating a success rate of block registration.

In some embodiments, a higher proportion of blocks that successfully complete registration and meet accuracy requirements (e.g., a count of points in a block is greater than or equal to the point count threshold of point cloud, the RMSE of corresponding points is less than or equal to the RMSE threshold, etc.) to all blocks of the three-dimensional surface deformation point cloud data of the current phase indicates better overall adaptability and registration effectiveness of the three-dimensional surface deformation point cloud data under the current key registration parameters.

The total count of successfully registered blocks refers to a total count of all point cloud blocks that satisfy preset success conditions in a complete process of point cloud stepwise registration calculation. For example, the processor may count blocks with a count of points in the blocks greater than or equal to the point count threshold of point cloud and the RMSE of corresponding points in the blocks less than or equal to the RMSE threshold, determine these blocks as successfully registered blocks, and determine a count of these blocks as the total count of successfully registered blocks.

The corresponding point pair refers to a pair of points that correspond to each other in two phases of point cloud blocks that are successfully registered.

In some embodiments of the present disclosure, by incorporating the global point cloud features, the calculation parameters, and registration evaluation indices (e.g., the point RMSE corresponding to the registration result, and the proportion of successfully matched blocks) into training data, the trained neural network model can comprehensively learn a correspondence relationship between different point cloud features and optimal parameters, which enables the neural network model to more accurately predict key calculation parameters suitable for current point cloud conditions in practical applications, thereby significantly improving reliability of registration and deformation interpretation. By simultaneously introducing the point RMSE corresponding to the registration result and the proportion of successfully matched blocks into the loss function, joint constraints on accuracy and stability are achieved, which enables the model to both reduce overall registration error and increase the proportion of effective blocks, avoiding situations of local optimum or large-scale block registration failure, thereby improving robustness of overall deformation calculation results.

The Bayesian optimization refers to a process of iteratively selecting optimal parameters through a prior model.

For example, the processor may perform iterative optimization using the Bayesian optimization algorithm based on key registration parameters output by the neural network. By evaluating different key registration parameters, the Bayesian optimization algorithm automatically searches for optimal key registration parameters that can simultaneously maximize registration accuracy (minimizing RMSE) and maximize matching success rate (maximizing P).

In 230, obtaining initial calculation points based on the optimal initial calculation point spacing, dividing to obtain initial point cloud blocks, performing preliminary registration using an average domain vector algorithm to obtain an initial transformation matrix, and decomposing the initial transformation matrix to obtain a translation vector and a rotation matrix.

The initial calculation points refer to spatial center points uniformly laid out within a coverage range of point cloud according to the initial calculation point spacing.

In some embodiments, the processor may draw a two-dimensional planar projection grid based on the initial calculation point spacing, and use grid intersections of the projection grid as the initial calculation points.

The initial point cloud blocks refer to blocks preliminarily divided based on the optimal key registration parameters.

In some embodiments, the processor may divide the two phases of three-dimensional surface deformation point cloud data into the initial point cloud blocks by taking the initial calculation point as a center and the minimum point cloud search radius as a radius.

The initial transformation matrix refers to a corresponding transformation matrix for superimposing the initial point cloud blocks of the three-dimensional surface deformation point cloud data of the current phase onto the initial point cloud blocks of the three-dimensional surface deformation point cloud data of another phase.

It can be understood that the initial point cloud blocks of the three-dimensional surface deformation point cloud data of the current phase may be superimposed onto the initial point cloud blocks of the three-dimensional surface deformation point cloud data of another phase by multiplying the initial point cloud blocks of the three-dimensional surface deformation point cloud data of the current phase by the initial transformation matrix.

The translation vector refers to a linear offset of a centroid of the initial point cloud blocks of the current phase relative to a centroid of the initial point cloud blocks of another phase.

The rotation matrix refers to attitude rotation of the initial point cloud blocks of the current phase relative to the initial point cloud blocks of another phase.

In some embodiments, the processor may obtain the initial calculation points based on the initial calculation point spacing, obtain the initial point cloud blocks based on the minimum point cloud search radius, and register the initial point cloud blocks with the other phase of point cloud blocks using the average domain vector algorithm based on the determined calculation parameters to obtain the initial transformation matrix M₀ of the initial point cloud blocks in first registration;

$${M}_{0} = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3} \\ 0 & 0 & 0 & 1\end{matrix} ]$$

Meanwhile, the processor may interpret the initial transformation matrix M₀ to obtain a translation vector \vec{t}⁰ and a rotation matrix of a current calculation point

$${m}_{r}^{0} .$$

In M₀, a matrix formed by r₁₁ to r₃₃ is the rotation matrix

$${m}_{r}^{0} .$$

and a vector formed by t₁ to t₃ is the translation vector \vec{t}⁰.

In some embodiments, the processor may preliminarily register two phases of initial point cloud blocks using the average domain vector algorithm to obtain the initial transformation matrix. The average domain vector algorithm refers to a manner for obtaining the initial transformation matrix.

For example, the processor may perform nearest neighbor registration for the initial point cloud blocks of the current phase in the three-dimensional surface deformation point cloud data of another phase, determine the initial point cloud blocks of another phase that are nearest neighbor to the initial point cloud blocks of the current phase, determine centroids of the initial point cloud blocks of the two phases, obtain a covariance matrix by removing the centroids, perform singular value decomposition on the covariance matrix to obtain the rotation matrix, obtain the translation vector based on a centroid difference, and determine the initial transformation matrix based on the translation vector and the rotation matrix.

In some embodiments, the processor may extract the translation vector and the rotation matrix based on the initial transformation matrix. For example, if the initial transformation matrix is

$${M}_{0} = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3} \\ 0 & 0 & 0 & 1\end{matrix} ] ,$$

the processor may use top-left 3×3 sub-blocks of the initial transformation matrix as a rotation matrix

$${m}_{r}^{0} = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] ,$$

and use top-right 3×1 sub-blocks of the initial transformation matrix as a translation vector

$${\vec{t}}^{0} = [ \begin{matrix}{t}_{1} \\ {t}_{2} \\ {t}_{3}\end{matrix} ] .$$

In some embodiments of the present disclosure, obtaining the initial point cloud blocks, registering the initial point cloud blocks using the average domain vector algorithm to obtain the initial transformation matrix, and interpreting the initial transformation matrix to obtain the translation vector and the rotation matrix of the current calculation point can avoid repeated blind trials, reduce manual selection workload, and prevent point cloud blocks from being too small and lacking features leading to local optimum, ensuring that subsequent iterations are performed only on blocks that are “sufficient and accurate”, and improving overall solution efficiency and accuracy.

In 240, reducing a calculation point spacing to obtain new calculation points, and performing weighted averaging on a rotation vector and the translation vector of previous calculation points adjacent to the new calculation points using inverse distance weighting to obtain initial transformation parameters of the new calculation points.

The calculation point spacing refers to a planar interval distance between calculation center points arranged within a range of the three-dimensional surface deformation point cloud data during division. In some embodiments, the calculation point spacing may represent a granularity of the division of the three-dimensional surface deformation point cloud data.

In some embodiments, the calculation point spacing may include the initial calculation point spacing.

In some embodiments, the processor may use half of a previous calculation point spacing as a reduced calculation point spacing for current calculation.

For example, the processor may determine the initial calculation points based on the initial calculation point spacing, insert the new calculation point at a central position between any two adjacent initial calculation points, and use a spacing between the new calculation point and the initial calculation point as the reduced calculation point spacing.

It can be understood that, each time the calculation point spacing is reduced, the new calculation points may be inserted between the previous calculation points, and a magnitude of reduction for the calculation point spacing each calculation is half of the previous calculation point spacing.

The inverse distance weighting (IDW) refers to a manner for obtaining the initial transformation parameters of the new calculation points.

In some embodiments, the IDW is weighted averaging. For a new calculation point, if a distance between the previous calculation point and the new calculation point is closer, a weight corresponding to the translation vector and the rotation matrix of the previous calculation point is greater.

The previous calculation point refers to a calculation point within a block during previous registration.

In some embodiments, the previous calculation points may include the initial calculation points.

The rotation vector refers to a vector transformed from the rotation matrix.

In some embodiments, the processor may determine a rotation angle and a rotation axis based on the rotation matrix, and determine the rotation vector based on the rotation angle and the rotation axis.

For example, the processor may use a product of the rotation angle and the rotation axis as the rotation vector.

The initial transformation parameter refers to a parameter for superimposing the new calculation point of the current phase onto the new calculation point of another phase.

In some embodiments, the initial transformation parameter may include an initial translation vector and an initial rotation matrix of the new calculation point.

The initial translation vector refers to a translation vector obtained through weighted averaging using IDW.

The initial rotation matrix refers to a matrix transformed from an initial rotation vector. The initial rotation vector refers to a rotation vector obtained through weighted averaging using IDW.

In some embodiments, the processor may determine the initial rotation matrix based on the initial rotation vector using Rodrigues' formula.

For example, if the initial rotation vector is r=θ·k (where k is a unit axis and θ is a rotation angle), the initial rotation matrix R is R=cosθ×I+(1−cosθ)×kk^{T}+sinθ×[k]×, where I is a 3×3 identity matrix, and [k]× is an antisymmetric matrix of k.

In some embodiments, the processor may reduce the calculation point spacing to obtain the new calculation points, for each of the new calculation points, find five nearest previous calculation points, convert the rotation matrix

$${m}_{r}^{0}$$

to a rotation vector

$${\vec{t}}_{r}^{0}$$

using axis-angle representation, perform weighted averaging on the translation vector and the rotation vector using the axis-angle representation of the five nearest previous calculation points using IDW to obtain an initial translation vector

$${\vec{t}}_{1}^{0}$$

and an initial rotation vector

$${\vec{t}}_{r 1}^{0}$$

using the axis-angle representation of a new calculation point;

$${\vec{t}}_{1}^{0} = \frac{{\sum }_{i = 1}^{n} {w}_{i} \cdot {\vec{t}}^{0 i}}{{\sum }_{i = 1}^{n} {w}_{i}}$$

where

$${\vec{t}}_{1}^{0}$$

represents the initial translation vector, n represents a count of nearest previous calculation points,

$${\vec{t}}^{0 i}$$

represents a translation vector of an i-th previous calculation point, wᵢ represents weights corresponding to nearest i calculation points, calculation of the weights being expressed as:

$${w}_{i} = \frac{1}{{d}_{i}}$$

where dᵢ represents a distance from an i-th nearest calculation point to the new calculation point; the initial rotation vector

$${\vec{t}}_{r 1}^{0}$$

is converted to an initial rotation matrix

$${m}_{r 1}^{0} .$$

The nearest calculation point refers to a previous calculation point that is most adjacent to the new calculation point.

In some embodiments, a maximum count of the nearest calculation points may be preset by a technician based on experience.

In some embodiments of the present disclosure, by reducing the calculation point spacing to obtain the new calculation points, determining the initial translation vector and the initial rotation vector using the axis-angle representation of a new calculation point, and determining the initial rotation matrix, loss of orthogonality in matrix averaging can be avoided, physical reasonableness of initial values is ensured, and the risk of falling into local optimum is reduced, improving overall solution accuracy and efficiency.

In some embodiments, the processor may combine and package the initial translation vector and the initial rotation matrix to form the initial transformation parameters.

In 250, rotating and translating the initial point cloud blocks to new positions based on the initial transformation parameters of the new calculation points, performing re-registration to obtain a new transformation matrix, and decomposing the new transformation matrix to obtain a new translation vector and a new rotation matrix.

The new positions refer to positions reached by the new calculation points in the initial point cloud blocks after rotation and translation.

In some embodiments, the processor may determine the new positions of the new calculation points based on the initial transformation matrix and the three-dimensional coordinate transpose of the new calculation points of the initial point cloud blocks.

For example, the processor may combine the initial rotation matrix and the initial translation vector in the initial transformation parameters to form the initial transformation matrix, left-multiply three-dimensional coordinate transpose of the new calculation points by the initial transformation matrix to obtain coordinate transpose of the new positions, and transpose the coordinate transpose of the new positions again to obtain coordinates of the new positions.

The new transformation matrix refers to a transformation matrix obtained by registration after translation and rotation of the new calculation points.

The new translation vector refers to a translation vector obtained by interpreting the new transformation matrix.

The new rotation matrix refers to a rotation matrix obtained by interpreting the new transformation matrix.

In some embodiments, the processor may convert the initial rotation vector

$${\vec{t}}_{r 1}^{0}$$

to the initial rotation matrix

$${m}_{r 1}^{0} ,$$

and rotate and translate a point cloud block A corresponding to the new calculation point to a new position A*,

$${A}^{*} = {m}_{r 1}^{0} \times A + {\vec{t}}_{1}^{0}$$

A represents coordinates of a point cloud block of previous calculation. A* represents coordinates of a new position after translation transformation of the point cloud block.

$${m}_{r 1}^{0}$$

represents the initial rotation matrix. The processor may perform re-registration on the point cloud block using the average domain vector algorithm to obtain a new transformation matrix M₂, interpret the new transformation matrix M₂ to obtain the new translation vector and the new rotation matrix, and superimpose the translation vector and the rotation matrix to obtain a current total deformation amount.

The current total deformation amount refers to a deformation amount of the point cloud blocks corresponding to the calculation points of the current phase.

In some embodiments, the processor may determine the new transformation matrix and the transformation matrix corresponding to the previous calculation points based on the new translation vector, the new rotation matrix, the translation vector and the rotation matrix corresponding to the previous calculation points. The processor may right-multiply the transformation matrix corresponding to the previous calculation points by the new transformation matrix to obtain a total transformation matrix. The processor may parse the total transformation matrix to obtain a total rotation matrix and a total translation vector. A modulus value of the total translation vector is the total deformation amount.

In some embodiments, determining the new transformation matrix and the transformation matrix corresponding to the previous calculation points is the same as determining the initial transformation matrix. Parsing the total transformation matrix to obtain the total rotation matrix and the total translation vector is the same as obtaining the initial rotation matrix and the initial translation vector. More descriptions regarding determining the initial transformation matrix, the initial translation vector, and the initial rotation matrix may be found in the step 230 of FIG. 2 and related descriptions thereof.

In some embodiments of the present disclosure, by determining the total deformation amount based on the new transformation matrix and the transformation matrix corresponding to the previous calculation points, the RMSE can be significantly reduced, a single block displacement error can be controlled to a millimeter level, large blocks are ensured to substantially coincide, subdivided blocks are less likely to fall into an error valley, global solution stability is improved, the displacement between neighboring blocks is smooth, and a final deformation field has no abrupt jumps.

In 260, repeating the step 240 and step 250, when a displacement of a current calculation point after certain registration is less than a specified threshold, assuming that a current calculation point spacing is d, determining calculation as completed when the displacement of the current calculation point is within a range of d/2, and when reducing the calculation point spacing next time, a region where the calculation point is located not taking the new calculation points but directly using the previous calculation points; and when the calculation point spacing is reduced to the specified threshold, determining calculation as completed after the current calculation ends.

The displacement of the calculation point may also be referred to as the total deformation amount.

The specified threshold refers to a parameter for determining whether calculation of a region where a block is located is complete.

In some embodiments, the specified threshold may be preset by the technician based on experience.

The calculation completed means that the new calculation point substantially overlaps the new calculation point of another phase after rotation and translation according to the total deformation amount, and subdivision of the block is no longer required.

In some embodiments, the processor may rotate and translate the new calculation point of the current phase according to the total deformation amount and superimpose the new calculation point of the current phase with the new calculation point of another phase. The processor may calculate a distance between the new calculation point of the current phase and the new calculation point of another phase. If the distance is less than the specified threshold, a block region where the new calculation point of the current phase is located is considered to have completed calculation. The block region may also be referred to as the point cloud block.

It can be understood that, the processor may reduce the calculation point spacing for the point cloud blocks that are not marked as calculation completed. If the point cloud block where the calculation point is located is marked as calculation completed after the calculation point spacing is reduced, the point cloud block may be excluded in subsequent reductions of the calculation point spacing. In response to all point cloud blocks of the three-dimensional surface deformation point cloud data of the current phase being marked as calculation completed, or the calculation point spacing reaching a minimum value, the three-dimensional surface deformation point cloud data of the current phase is considered to have completed overall calculation.

In some embodiments, in each iteration of executing the S4 and S5, the processor may determine the maximum correspondence point search distance, the minimum point cloud search radius, and the point count threshold of point cloud to be used in a next iteration based on a point cloud local density, a regional slope, and a regional roughness of a current iteration.

The point cloud local density refers to a distribution of a count of points in a local point cloud block.

In some embodiments, the higher the point cloud local density, the greater the count of points in the local point cloud block.

The regional slope refers to an inclination degree of a terrain surface corresponding to the local point cloud block.

In some embodiments, the regional slope may reflect geometric complexity of the terrain.

The regional roughness refers to a geometric texture intensity or a surface fluctuation degree of a ground surface corresponding to the local point cloud block.

In some embodiments, the processor may determine the regional slope and the regional roughness based on the three-dimensional surface deformation point cloud data through statistical analysis manners (e.g., principal component analysis, local least squares plane fitting, etc.).

In some embodiments, the processor may determine the maximum correspondence point search distance, the minimum point cloud search radius, and the point count threshold of point cloud by matching first vector data based on the point cloud local density, the regional slope, and the regional roughness.

In some embodiments, the processor may construct a first vector database based on a historical point cloud local density, a historical regional slope, a historical regional roughness, a historical maximum correspondence point search distance, a historical minimum point cloud search radius, and a historical point count threshold of point cloud from historical registration of historical local point cloud blocks. The first vector database may include a relationship among the point cloud local density, the regional slope, the regional roughness, the maximum correspondence point search distance, the minimum point cloud search radius, and the point count threshold of point cloud of the local point cloud block.

The processor may construct the historical point cloud local density, the historical regional slope, and the historical regional roughness of the historical local point cloud blocks in the first vector database into first feature vectors, and use a set of a plurality sets of historical maximum correspondence point search distances, historical minimum point cloud search radii, and historical point count thresholds of point cloud corresponding to the first feature vectors as labels of the first feature vectors. The registration effect refers to a point RMSE corresponding to a registration result after registration. The smaller the point RMSE, the better the registration effect.

In some embodiments, the processor may construct a first target vector based on the point cloud local density, the regional slope, and the regional roughness corresponding to the three-dimensional surface deformation point cloud data of the current phase. The processor may calculate a similarity between the first target vector and the first feature vectors. The processor may use a label corresponding to a first feature vector with a greatest similarity as the maximum correspondence point search distance, the minimum point cloud search radius, and the point count threshold of point cloud corresponding to the first target vector. Manners for calculating the similarity include, but are not limited to, Euclidean distance, cosine similarity, etc.

In some embodiments, the processor may adjust the maximum correspondence point search distance, the minimum point cloud search radius, and the point count threshold of point cloud based on effective registration results of the previous iteration.

The effective registration results refer to the transformation parameters that are confirmed to have converged and have an error within an allowable range after calculation of the previous iteration is completed. In some embodiments, the effective registration results may include the rotation matrix and the translation vector.

In some embodiments, the processor may determine an adjusted maximum correspondence point search distance, an adjusted minimum point cloud search radius, and an adjusted point count threshold of point cloud by querying a first preset table based on the rotation matrix and the translation vector of the previous calculation points. The first preset table may include a relationship among the rotation matrix, the translation vector, the maximum correspondence point search distance, the minimum point cloud search radius, and the point count threshold of point cloud.

In some embodiments, the first preset table may be preset by the technician based on experience.

It can be understood that the larger the magnitude of the translation vector, the larger the movement amplitude of the current iteration, which indicates that the registration is crossing a large distance, and the current region may be in a large deformation stage. Accordingly, a larger maximum correspondence point search distance may be set to prevent loss of a target due to a sudden reduction in the search range. Meanwhile, for a large deformation region, the requirements for the reliability of data is higher. Therefore, the point count threshold of point cloud for a next iteration should be set relatively strictly. A larger rotation angle corresponding to the rotation matrix indicates that the local point cloud block region is undergoing rolling, toppling, or severe twisting, and a block radius cannot be rapidly reduced at this time. Because if a field of view is too small (i.e., the radius is too small), geometric features are easily lost under severe rotation, leading to matching failure. Therefore, the minimum point cloud search radius for the next iteration remains unchanged or is slowly reduced.

In some embodiments of the present disclosure, by using the effective transformation results of the previous iteration to calculate parameters of the current iteration, the stability of multi-scale gradual convergence during a coarse-to-fine process of point cloud registration is ensured.

In some embodiments of the present disclosure, by adaptively adjusting the registration parameters in real time according to terrain features, cross-slope mismatching and registration failure in steep slope or low-density regions can be avoided, ensuring registration accuracy of each iteration.

In some embodiments, before executing step S4 in each iteration, the processor may obtain an average displacement of the calculation points in a plurality of monitoring regions; in response to the average displacement of the calculation points being less than a change threshold, use the previous calculation points in a corresponding point cloud block region.

The average displacement of the calculation points refers to an average value of displacements of the calculation points relative to the previous calculation points within the monitoring region.

In some embodiments, the average displacement of the calculation points may be used for measuring deformation activity of the region.

The change threshold refers to a parameter for determining whether to continue using the calculation points from the previous iteration.

In some embodiments, the change threshold may be preset by the technician based on experience.

In some embodiments, the processor may determine the change threshold by matching a second vector database based on an RMSE of the calculation points from the previous iteration, the region roughness, and the minimum point cloud search radius.

In some embodiments, the processor may construct the second vector database based on a historical RMSE, a historical region roughness, a historical minimum point cloud search radius, and a historical change threshold. The second vector database may include a relationship among the historical RMSE, the historical region roughness, the historical minimum point cloud search radius, and the historical change threshold.

The processor may construct second feature vectors of the second vector database based on the historical RMSE, the historical region roughness, and the historical minimum point cloud search radius, use one of a plurality of historical change thresholds corresponding to the second feature vectors that yields an optimal subsequent iteration effect as a label corresponding to the second feature vector. The optimal iteration effect refers to a situation where a count of calculation points actually participating in a next iteration calculation decreases most and a relative accuracy loss is smallest.

In some embodiments, the processor may construct a second target vector based on the RMSE of the calculation points from the previous iteration corresponding to the three-dimensional surface deformation point cloud data of the current phase, the region roughness, and the minimum point cloud search radius, determine a similarity between the second target vector and the second feature vectors, and use a label corresponding to a second feature vector with a greatest similarity as the change threshold corresponding to the second target vector.

In some embodiments of the present disclosure, by directly reusing the calculation points from the previous iteration in regions with stable local displacement changes, redundant calculation in the subsequent process of spacing reduction is reduced and overall iteration efficiency is improved.

In 270, interpreting to obtain a translation vector \vec{t}ⁿ corresponding to the calculation points based on all calculation points and corresponding transformation matrices in final calculation, and superimposing the translation vector \vec{t}ⁿ with an initial translation vector \vec{t}ⁿ⁻¹ of the current calculation to obtain a total translation vector \vec{t}^{total} of the calculation points;

$${\vec{t}}^{total} = {\vec{t}}^{n - 1} + {\vec{t}}^{n}$$

obtaining a global displacement and deformation field of a calculation region.

The final calculation refers to last registration performed after the calculation point spacing reaches a minimum value and calculations for all regions where the calculation points are located are completed.

The total translation vector refers to a spatial movement amount of a surface position corresponding to the calculation point.

In some embodiments, the processor may superimpose the translation vector \vec{t}ⁿ corresponding to the calculation point obtained through interpretation with the initial translation vector \vec{t}ⁿ⁻¹ of the current iteration to obtain the total translation vector \vec{t}^{total}.

The displacement and deformation field refers to a continuous vector field formed by interpolating total displacement vectors of all calculation points from the final iteration in three-dimensional space.

In some embodiments, the displacement and deformation field may be used for describing a magnitude and a direction of the spatial displacement of each point on a surface within the entire monitoring region.

In some embodiments, the processor may extract the total displacement vectors and coordinates of all converged calculation points, and generate a displacement vector grid covering the entire region through gridding or Kriging interpolation, which is the displacement and deformation field. The entire region refers to a geographical region covered by the three-dimensional surface deformation point cloud data.

In some embodiments, the processor may determine a plurality of deformation rate distributions based on a plurality of historical displacement and deformation fields at each preset period; determine a local deformation rate of a plurality of monitoring regions based on the deformation rate distributions; in response to the local deformation rate satisfying a scheduling condition, generate a scheduling instruction based on the local deformation rate and send the scheduling instruction to a surface monitoring device or an inspection UAV; wherein the surface monitoring device scans the monitoring regions and collects data based on the scheduling instruction; the inspection UAV performs a re-scan on the monitoring regions based on the scheduling instruction.

The preset period may be 1 h, 2 h, or the like.

In some embodiments, the preset period may be preset by the technician based on experience.

The historical displacement and deformation fields refer to a plurality of displacement and deformation fields calculated within historical preset periods.

The deformation rate distribution refers to a distribution of deformation rates of the displacement and deformation field.

In some embodiments, the processor may determine the deformation rate distribution in various ways.

For example, for each of the historical displacement and deformation fields, the processor may obtain historical displacements of a plurality of calculation points on the entire region, divide the historical displacement of each calculation point by a corresponding time interval between two phases of historical data to obtain a historical deformation rate of each calculation point, thereby obtaining the deformation rate distribution corresponding to the historical displacement and deformation field.

The monitoring region refers to a region within the entire region that requires monitoring.

The local deformation rate refers to an average deformation rate within the monitoring region during a previous preset period.

In some embodiments, the local deformation rate reflects a sliding trend of local soil or structure.

In some embodiments, the processor may determine the local deformation rate in various ways.

For example, for each of the monitoring regions, the processor may use an average of deformation rates of a plurality of location points within the monitoring region at a certain moment as the average deformation rate of the monitoring region at the certain moment.

The scheduling condition refers to a condition for scheduling the surface monitoring device or the inspection UAV to work.

For example, the scheduling condition may be that at least two or more average deformation rates of the local deformation rates show a continuous upward trend, or any one of the at least two or more average deformation rates exceeds a first threshold.

The scheduling instruction refers to an operation command sent by a control system to hardware devices (e.g., the surface monitoring device or the UAV).

In some embodiments, the scheduling instruction may be used for changing an operation state of the device or to execute a specific task, including a scanning frequency and a collection resolution of the surface monitoring device, and/or a re-scan region of the inspection UAV.

The scanning frequency refers to a time period for the surface monitoring device to execute a data collection task on the monitoring region or an operation frequency per unit time. The scanning frequency reflects a refresh rate of monitoring data in a temporal dimension.

The collection resolution refers to a point density of point cloud data acquired by the surface monitoring device per unit area or a spatial step between adjacent measurement points. The collection resolution reflects a degree of detail refinement of the monitoring data in a spatial dimension.

The re-scan region refers to a region where the inspection UAV performs a secondary scan. The re-scan refers to performing a scan again.

In some embodiments, the processor may query a second preset table based on an average difference between the local deformation rate and the first threshold (hereinafter referred to as a rate average difference) to determine a scanning frequency increase ratio and a collection resolution increase ratio. The second preset table may include a relationship among the rate average difference, the scanning frequency increase ratio, and the collection resolution increase ratio. In some embodiments, the second preset table may be preset by the technician based on experience.

In some embodiments, the processor may multiply an original scanning frequency and an original collection resolution of the surface monitoring device by the found scanning frequency increase ratio and the found collection resolution increase ratio, respectively, to obtain a scanning frequency and a collection resolution that the current surface monitoring device or the inspection UAV should execute.

The surface monitoring device refers to a device for acquiring the three-dimensional surface deformation point cloud data. For example, the surface monitoring device may be a terrestrial three-dimensional laser scanner.

It can be understood that when scanning each monitoring region, the surface monitoring device automatically increases the scanning frequency and the collection resolution by a corresponding increase ratio, scans the monitoring region at the increased scanning frequency, and collects data at the increased collection resolution during each scan.

In some embodiments, the inspection UAV may increase the scanning frequency and the collection resolution based on the scheduling instruction and perform the re-scan on the monitoring region.

In some embodiments, the processor may determine a plurality of potential instability regions according to the local deformation rate; determine a cumulative displacement of each of the potential instability regions based on the historical displacement and deformation fields; in response to a determination that the cumulative displacement is greater than or equal to an early warning threshold, send a control instruction to a monitoring terminal, the monitoring terminal activating an audible and visual alarm device to issue an alarm or activating a remote transmission device to send alarm information based on the control instruction.

The potential instability region refers to a monitoring region determined through analysis of the displacement and deformation field, which has a risk of landslide or structural failure.

In some embodiments, the processor may determine the potential instability regions in a plurality of ways.

For example, the processor may use a monitoring region where any one of a plurality of average deformation rates corresponding to the local deformation rate exceeds a second threshold as the potential instability region.

In some embodiments, the second threshold is less than the first threshold.

The cumulative displacement refers to an average cumulative displacement of the potential instability regions in the previous preset period.

In some embodiments, the processor may obtain the cumulative displacement in a plurality of ways.

For example, the processor may obtain historical displacements corresponding to each calculation point in the potential instability regions in the plurality of historical displacement and deformation fields; for each calculation point, use a sum of the plurality of historical displacements of the calculation point as the cumulative displacement corresponding to the calculation point; use an average value of the cumulative displacements of the plurality of calculation points in the potential instability regions as the cumulative displacement of the potential instability regions.

The early warning threshold refers to a parameter that triggers an alarm.

In some embodiments, the early warning threshold may be preset by the technician based on experience.

The control instruction refers to a signal sent to an on-site monitoring terminal.

In some embodiments, the control instruction may be used for triggering the action of an alarm hardware or a communication module.

In some embodiments, the control instruction may include an alarm frequency or alarm information.

The alarm frequency refers to a frequency at which the audible and visual alarm device issues the alarm.

The alarm information includes a position and the cumulative displacement of the potential instability region where the cumulative displacement exceeds the early warning threshold.

In some embodiments of the present disclosure, by monitoring the cumulative displacement and triggering hardware actions when a limit is exceeded, immediate on-site audible and visual warnings and remote data synchronization for the risk of instability are achieved.

In some embodiments of the present disclosure, by automatically scheduling devices to increase the collection frequency or resolution when the local deformation rate increases, high-precision data for key regions is obtained, avoiding false warnings due to insufficient data.

In some embodiments of the present disclosure, to solve the technical problems existing in the background technology, the objective is to provide the method for non-contact monitoring of three-dimensional global landslide deformation with millimeter-level accuracy. To utilize sufficient features of large-area point cloud, during preliminary registration, sufficiently large point cloud blocks are delineated, and preliminary deformation information is obtained through registration. Then, the point cloud blocks are gradually reduced in size, and a deformation value obtained from the previous block registration is assigned to the point cloud blocks according to the weight, causing the point cloud blocks to gradually approach correct matching positions, thereby avoiding directly taking the smallest point cloud block which may cause the algorithm to fall into a local optimum due to insufficient features. After calculation results reach a target accuracy, the calculation is completed. The final transformation matrix of the point cloud blocks is obtained through the transformation matrix obtained at each registration, thereby further interpreting to obtain a detailed global deformation field of the analysis region. The entire process of stepwise block registration is implemented by programs, which has low workload. Meanwhile, the process of stepwise registration calculation involves many calculation parameters. By using a large amount of stepwise registration experimental data to train the neural network model and using the Bayesian optimization algorithm to infer optimal parameters, the cost of manual trial and error can be greatly reduced, and the accuracy of the deformation interpretation results can be improved.

Specific implementations of the present disclosure are described below with reference to the embodiments.

### Embodiment 1

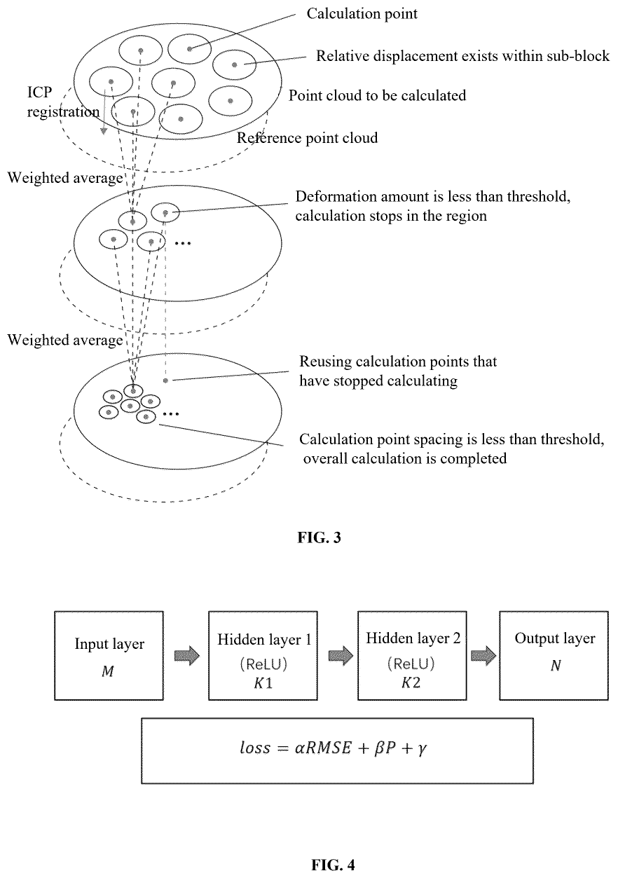

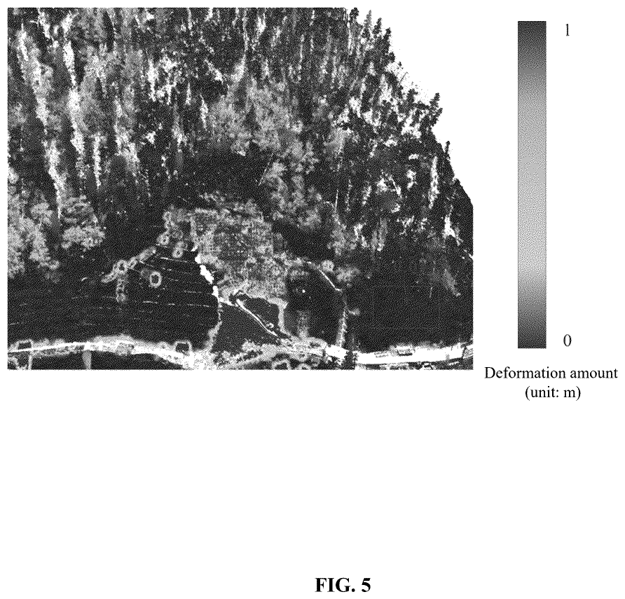

FIG. 3 is a schematic diagram illustrating an exemplary process of stepwise calculation according to some embodiments of the present disclosure.

FIG. 4 is a schematic diagram illustrating an exemplary process of network training according to some embodiments of the present disclosure.

As shown in FIGS. 3-4, a method for non-contact monitoring of three-dimensional global landslide deformation with millimeter-level accuracy is provided, with specific technical solutions as follows:

(1) Two phases of three-dimensional surface deformation point cloud data for deformation interpretation are prepared. Regions covered by the two phases of three-dimensional surface deformation point cloud data should correspond.

(2) Global point cloud features of the three-dimensional surface deformation point cloud data are obtained, including an average density of point cloud, a smoothness degree, a size, a terrain type, a data acquisition manner, an average deformation estimate, etc.

(3) According to the global point cloud features obtained in (2) and a trained neural network model, optimization is performed using a Bayesian optimization algorithm to obtain key parameters required subsequently, including an optimal initial calculation point spacing, a minimum point cloud search radius, a maximum correspondence point search distance, a point count threshold of point cloud, an RMSE threshold, etc. Data used for training includes the point cloud features (the average density of point cloud, the size of point cloud, a magnitude of deformation amount, the terrain type, a manner of point cloud acquisition, and the smoothness degree of point cloud), calculation parameters (the minimum point cloud search radius, the maximum correspondence point search distance, the point count threshold of point cloud, and the RMSE threshold), a point RMSE corresponding to a registration result, a proportion of successfully matched blocks. A loss function mainly considers the RMSE of registration results and the proportion of successfully matched blocks. A calculation formula of the loss function is expressed as the following formula:

$$loss = α RMSE + β P + γ$$

Where MSE represents an average RMSE of all block matching results; P represents the proportion of successfully matched blocks; α, β, γ are hyperparameters;

The average RMSE of all block matching results is calculated by the following formula:

$$RMSE = \frac{{\sum }_{i = 1}^{{n}^{S}} {RMSE}_{i}}{{n}^{S}}$$

Where n^{s} represents a total count of successfully registered blocks, RMSEᵢ represents an RMSE of a corresponding point pair after registration of an i-th block, and a calculation manner of RMSEᵢ is expressed as:

$${RMSE}_{i} = \sqrt{\frac{{\sum }_{j = 1}^{{n}_{i}} ( ( {x}_{j}^{a} - {x}_{j}^{b} ) + ( {y}_{j}^{a} - {y}_{j}^{b} ) + ( {z}_{j}^{a} - {z}_{j}^{b} ) )}{{n}_{i}}}$$

Where nᵢ represents a count of points contained in the i-th block, xⱼ^{a}, yⱼ^{a}, zⱼ^{a} represent coordinates of a j-th point in the i-th block, xⱼ^{b}, yⱼ^{b}, zⱼ^{b} represent coordinates of matching points of the j-th point in the i-th block in a block of another phase.

A calculation manner of the proportion P of successfully matched blocks is expressed as:

$$P = \frac{{n}^{S}}{n}$$

Wherein n^{s} represents the total count of successfully registered blocks, and n represents a total count of blocks.

(4) Initial calculation points are obtained based on the initial calculation point spacing, initial point cloud blocks are obtained based on the point cloud search radius, and the calculation parameters determined in (3) are used to register the initial point cloud blocks with point cloud blocks of another phase using an average domain vector algorithm to obtain an initial transformation matrix M₀ of the initial point cloud blocks in first registration.

$${M}_{0} = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3} \\ 0 & 0 & 0 & 1\end{matrix} ]$$

Meanwhile, the initial transformation matrix is interpreted to obtain a translation vector \vec{t}⁰ and a rotation matrix

$${m}_{r}^{0}$$

of a current calculation point.

(5) The calculation point spacing is reduced to obtain new calculation points. For each of the new calculation points, five nearest previous calculation points are found, the rotation matrix

$${m}_{r}^{0}$$

is converted into a rotation vector

$${\vec{t}}_{r 1}^{0}$$

using an axis-angle representation, weighted averaging is performed on the translation vector and the rotation vector using the axis-angle representation of the five nearest previous calculation points using IDW to obtain an initial translation vector

$${\vec{t}}_{1}^{0}$$

and an initial rotation vector

$${\vec{t}}_{r 1}^{0}$$

using the axis-angle representation of a new calculation point.

$${\vec{r}}_{1}^{0} = \frac{{\sum }_{i = 1}^{n} {w}_{i} \cdot {\vec{t}}^{0 i}}{{\sum }_{i = 1}^{n} {w}_{i}}$$

Where wᵢ represents weights corresponding to the nearest i calculation points, calculation of the weights being expressed as:

$${w}_{i} = \frac{1}{{d}_{i}}$$

Where dᵢ represents a distance from an i-th nearest calculation point to the new calculation point.

The initial rotation vector

$${\vec{t}}_{r 1}^{0}$$

is converted into an initial rotation matrix

$${m}_{r 1}^{0} .$$

(6) The initial rotation vector

$${\vec{t}}_{r 1}^{0}$$

is converted into the initial rotation matrix

$${m}_{r 1}^{0} .$$

A point cloud block A corresponding to the new calculation point is rotated and translated to a new position A*.

$${A}^{*} = {m}_{r 1}^{0} \times A + {\vec{t}}_{1}^{0}$$

Re-registration is performed on the point cloud block using the average domain vector algorithm to obtain a new transformation matrix M₂, the new translation vector and the new rotation matrix are interpreted, and the translation vector and the rotation matrix are superimposed to obtain a current total deformation amount.

(7) Steps (5) and (6) are repeated. When a displacement of a current calculation point after certain registration is less than a specified threshold, assuming that a current calculation point spacing is d, calculation is determined as completed when the displacement of the current calculation point is within a range of d/2, and when reducing the calculation point spacing next time, a region where the calculation point is located does not take the new calculation points but directly uses the previous calculation points; and when the calculation point spacing is reduced to the specified threshold, calculation is determined as completed after the current calculation ends.

(8) Interpretation is performed to obtain a translation vector \vec{t}ⁿ corresponding to the calculation points based on all calculation points and corresponding transformation matrices in final calculation, and the translation vector \vec{t}ⁿ is superimposed with an initial translation vector \vec{t}ⁿ⁻¹ of the current calculation to obtain a total translation vector \vec{t}^{total} of the calculation points.

$${\vec{t}}^{total} = {\vec{t}}^{n - 1} + {\vec{t}}^{n}$$

Therefore, a global displacement and deformation field of the calculation region can be obtained.

### Embodiment 2

The present disclosure provides a method for non-contact monitoring of three-dimensional global landslide deformation with millimeter-level accuracy. A landslide analysis case in Liangshan Prefecture, Sichuan Province is used as example:
(1) Two phases of three-dimensional surface deformation point cloud data of a landslide in Liangshan Prefecture, Sichuan Province are available. After processing with RiSCAN Pro software, two phases of corresponding three-dimensional surface deformation point cloud data of a deformation analysis region are obtained.
(2) An average density of the point cloud data, a size of point cloud, a preliminary estimated average deformation amount, a manner of point cloud acquisition (three-dimensional laser scanning), a smoothness degree of the point cloud (obtained via PointNet), and a terrain type (mountainous terrain with vegetation) are counted. The above features are converted into corresponding data and input into a trained neural network model. Recommended calculation parameters are obtained via Bayesian optimization: a minimum point cloud search radius (0.8 m), a maximum correspondence point search distance (2.2 m), a minimum point count of a block (63), and an RMSE threshold (0.19 m).
(3) The above parameters are input into stepwise registration programs for stepwise calculation. The specific process is as follows:

A calculation point spacing is preliminarily set to ⅕ of a lateral size of point cloud. Block search deformation is set to a larger value between ½ of the calculation point spacing and the minimum point cloud search radius (0.8 m). A block with a point count less than 63 is considered invalid data. The registration with an RMSE greater than 0.19 m during the registration process is considered a misregistration and is discarded as interference data. A maximum search radius in the ICP registration process is set to 2.2 m. After the final block processing, deformation data for 238,404 calculation points are obtained, thereby generating an overall deformation field within the region.

(4) To verify the quality of the deformation field result obtained in step (3) of the method, a true displacement amount is obtained by manually calculating a coordinate difference of obvious feature points in the original point cloud data. Meanwhile, the deformation calculation result is obtained using a shortest distance method and an M3C2 method for comparison, as shown in Table 1:

TABLE 1
Comparison of displacement calculation results of different
methods at a plurality of points (unit: m)

| | | Calculation method | | |
|---|---|---|---|---|
| | | | Shortest | |
| Calculation | True | | distance | |
| point | displacement | The method | method | M3C2 method |
| 1 | 0.85 | 0.87 (+0.02) | 0.53 (−0.32) | 0.62 (−0.23) |
| 2 | 0.31 | 0.32 (+0.01) | 0.30 (−0.01) | 0.35 (+0.04) |
| 3 | 1.13 | 1.11 (−0.02) | 0.72 (−0.41) | 1.21 (+0.08) |
| 4 | 1.22 | 1.22 (+0) | 0.41 (−0.81) | 0.87 (−0.41) |
| 5 | 0.62 | 0.61 (−0.01) | 0.45 (−0.17) | 0.48 (−0.14) |

It can be seen that the displacement amount calculated by the method is generally closer to the true displacement with a smaller gap, proving that the result has higher accuracy and is superior.

(5) To further verify the accuracy of the method, a quarry slope in Aba Prefecture, Sichuan Province was selected for analysis. The global deformation field of the analysis region was generated according to the above steps. A portion of the deformation results in stable regions were selected in the deformation interpretation results for analysis. The results show that the deformation interpretation results within the stable regions are all within 1 cm, proving that the method achieves millimeter-level accuracy.

### Embodiment 3

The present disclosure provides a terminal device. The terminal device includes a processor and a memory. The memory is configured to store computer programs. The computer programs include program instructions. The processor is configured to execute the program instructions stored in a computer-readable storage medium. The processor may be a central processing unit (CPU), or may be another general-purpose processor, a digital signal processor (DSP), an application specific integrated circuit (ASIC), a field-programmable gate array (FPGA), or another programmable logic device, a discrete gate or transistor logic device, or a discrete hardware component. The processor is a computing core and a control core of the terminal, and configured to implement one or more instructions. Specifically, the processor is configured to load and execute the one or more instructions to implement a corresponding method process or a corresponding function. The processor described in the embodiments of the present disclosure may be used for operations of a method for non-contact monitoring of three-dimensional global landslide deformation with millimeter-level accuracy, including the following steps:

First, calculation points are selected at a certain distance in original three-dimensional surface deformation point cloud data to form an initial point cloud block. Next, the initial point cloud block is registered with the three-dimensional surface deformation point cloud data of another phase by using an average domain vector algorithm to interpret current deformation data. Then a spacing between the calculation points is reduced to obtain calculation points with a finer granularity. An initial deformation amount of adjacent calculation points is used as a reference for a current calculation point by using a distance weight. The registration step is repeated, and calculation results are superimposed. When the spacing is reduced to a specified threshold or the deformation amount is less than a set threshold, calculation of the current region is stopped. During the calculation process, key parameters such as a block radius, a registration search distance, and outlier removal are automatically determined by a trained neural network model combined with Bayesian optimization.

### Embodiment 4

The present disclosure provides a storage medium, specifically a non-transitory computer-readable storage medium (memory). The non-transitory computer-readable storage medium is a memory device in a terminal device and is configured to store programs and data. It can be understood that the non-transitory computer-readable storage medium herein may include a built-in storage medium in the terminal device, and may also include an extended storage medium supported by the terminal device. The non-transitory computer-readable storage medium provides a storage space. The storage space stores an operating system of the terminal. Moreover, one or more instructions suitable to be loaded and executed by the processor are also stored in the storage space. The one or more instructions may be one or more computer programs (including program codes). It should be noted that the non-transitory computer-readable storage medium herein may be a high-speed random access memory (RAM), or may be a non-volatile memory, such as at least one disk memory.

The one or more instructions stored in the non-transitory computer-readable storage medium may be loaded and executed by the processor to implement corresponding steps related to the method for non-contact monitoring of three-dimensional global landslide deformation with millimeter-level accuracy in the foregoing embodiments. The one or more instructions in the non-transitory computer-readable storage medium are loaded and executed by the processor to implement the method for non-contact monitoring of three-dimensional global landslide deformation with millimeter-level accuracy.

Those skilled in the art should understand that embodiments of the present disclosure may be provided as a method, a system, or a computer program product. Therefore, the present disclosure may adopt a form of a complete hardware embodiment, a complete software embodiment, or an embodiment combining software and hardware aspects. Moreover, the present disclosure may adopt a form of a computer program product implemented on one or more non-transitory computer-usable storage media (including but not limited to a disk memory, a CD-ROM, an optical memory, etc.) containing computer-usable program code.

The present disclosure is described with reference to flowcharts and/or block diagrams of methods, devices (systems), and computer program products according to the embodiments of the present disclosure. It should be understood that each process and/or block in the flowcharts and/or block diagrams, and a combination of processes and/or blocks in the flowcharts and/or block diagrams may be implemented by computer program instructions. The computer program instructions may be provided to the processor of a general-purpose computer, a special-purpose computer, an embedded processor, or another programmable data processing device to produce a machine, so that instructions executed by the processor of the computer or the other programmable data processing device produce means for implementing functions specified in one or more processes in the flowcharts and/or one or more blocks in the block diagrams.

The computer program instructions may also be stored in a computer-readable memory that can guide a computer or another programmable data processing device to work in a specific manner, so that the instructions stored in the computer-readable memory produce a manufactured product including an instruction means. The instruction means implements functions specified in one or more processes in the flowcharts and/or one or more blocks in the block diagrams.

The computer program instructions may also be loaded onto a computer or another programmable data processing device, so that a series of operation steps are executed on the computer or the other programmable device to produce computer-implemented processing. Therefore, instructions executed on the computer or the other programmable device provide steps for implementing functions specified in one or more processes in the flowcharts and/or one or more blocks in the block diagrams.

The foregoing describes the preferred embodiments of the present disclosure in detail. However, the present disclosure is not limited to the foregoing embodiments. Within the scope of knowledge possessed by those having ordinary skills in the art, various changes may be made without departing from the spirit of the present disclosure.

Many other changes and modifications may be made without departing from the concept and scope of the present disclosure. It should be understood that the present disclosure is not limited to specific embodiments. The scope of the present disclosure is defined by the appended claims.

What is claimed is:

1. A method for non-contact monitoring of three-dimensional global landslide deformation with millimeter-level accuracy, comprising:
S1: acquiring two phases of three-dimensional surface deformation point cloud data for deformation interpretation, and extracting global point cloud features;
S2: performing optimization using a Bayesian optimization algorithm based on the global point cloud features and a trained neural network model to obtain an optimal initial calculation point spacing, a minimum point cloud search radius, a maximum correspondence point search distance, a point count threshold of point cloud, and a root mean square error (RMSE) threshold;
S3: obtaining initial calculation points based on the optimal initial calculation point spacing, dividing to obtain initial point cloud blocks, performing preliminary registration using an average domain vector algorithm to obtain an initial transformation matrix, and decomposing the initial transformation matrix to obtain a translation vector and a rotation matrix;
S4: reducing a calculation point spacing to obtain new calculation points, and performing weighted averaging on a rotation vector and the translation vector of previous calculation points adjacent to the new calculation points using inverse distance weighting to obtain initial transformation parameters of the new calculation points;
S5: rotating and translating the initial point cloud blocks to new positions based on the initial transformation parameters of the new calculation points, performing re-registration to obtain a new transformation matrix, and decomposing the new transformation matrix to obtain a new translation vector and a new rotation matrix;
S6: repeating the S4 and S5, when a displacement of a current calculation point after certain registration is less than a specified threshold, assuming that a current calculation point spacing is d, determining calculation as completed when the displacement of the current calculation point is within a range of d/2, and when reducing the calculation point spacing next time, a region where the calculation point is located not taking the new calculation points but directly using the previous calculation points; and when the calculation point spacing is reduced to the specified threshold, determining calculation as completed after current calculation ends;
after the S6, the method further comprising:
interpreting to obtain a translation vector \vec{t}ⁿ corresponding to the calculation points based on all calculation points and corresponding transformation matrices in final calculation, and superimposing the translation vector \vec{t}ⁿ with an initial translation vector \vec{t}ⁿ⁻¹ of the current calculation to obtain a total translation vector \vec{t}^{total} of the calculation points;
$${\vec{t}}^{total} = {\vec{t}}^{n - 1} + {\vec{t}}^{n}$$
obtaining a global displacement and deformation field of a calculation region.

2. The method according to claim 1, wherein in S2,
data for training includes the global point cloud features, calculation parameters, a point RMSE corresponding to a registration result, and a proportion of successfully matched blocks;
a loss function considers an RMSE of the registration result and the proportion of successfully matched blocks, a calculation formula of the loss function being expressed as:
$$loss = α RMSE + β P + γ$$
wherein RMSE represents an average RMSE of all block matching results; P represents the proportion of successfully matched blocks; α, β and γ represent hyperparameters, respectively;
the average RMSE of the all block matching results is calculated by:
$$RMSE = \frac{{\sum }_{i = 1}^{{n}^{S}} {RMSE}_{i}}{{n}^{S}}$$
wherein n^{s} represents a total count of successfully registered blocks, RMSE; represents an RMSE of a corresponding point pair after registration of an i-th block, calculation of the RMSE of the corresponding point pair being expressed as:
$${RMSE}_{i} = \sqrt{\frac{{\sum }_{j = 1}^{{n}_{i}} ( ( {x}_{j}^{a} - {x}_{j}^{b} ) + ( {y}_{j}^{a} - {y}_{j}^{b} ) + ( {z}_{j}^{a} - {z}_{j}^{b} ) )}{{n}_{i}}}$$
wherein nᵢ represents a count of points contained in the i-th block; xⱼ^{a}, yⱼ^{a} and zⱼ^{a} represent coordinates of a j-th point in the i-th block; xⱼ^{b}, yⱼ^{b}, and zⱼ^{b} represent coordinates of a matching point of the j-th point in the i-th block in another phase of block;
the proportion P of successfully matched blocks is expressed as:
$$P = \frac{{n}^{s}}{n}$$
wherein n^{s} represents the total count of successfully registered blocks, and n represents a total count of blocks.

3. The method according to claim 1, wherein the S3 includes:
obtaining the initial calculation points based on the initial calculation point spacing, obtaining the initial point cloud blocks based on the minimum point cloud search radius, and registering the initial point cloud blocks with the other phase of point cloud blocks using the average domain vector algorithm based on calculation parameters to obtain an initial transformation matrix M₀ of the initial point cloud blocks in first registration;
$${M}_{0} = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3} \\ 0 & 0 & 0 & 1\end{matrix} ]$$
and interpreting the initial transformation matrix M₀ to obtain a translation vector \vec{t}⁰ and a rotation matrix
$${m}_{r}^{0}$$
of a current calculation point.

4. The method according to claim 1, wherein the S4 includes:
reducing the calculation point spacing to obtain the new calculation points, for each of the new calculation points, finding five nearest previous calculation points, converting a rotation matrix
$${m}_{r}^{0}$$
to a rotation vector
$${\vec{t}}_{r}^{0}$$
using axis-angle representation, performing weighted averaging on the translation vector and the rotation vector using the axis-angle representation of the five nearest previous calculation points using the inverse distance weighting to obtain an initial translation vector
$${\vec{t}}_{1}^{0}$$
and an initial rotation vector
$${\vec{t}}_{r 1}^{0}$$
using the axis-angle representation of a new calculation point;
$${\vec{t}}_{1}^{0} = \frac{{\sum }_{i = 1}^{n} {w}_{i} \cdot {\vec{t}}^{0 i}}{{\sum }_{i = 1}^{n} {w}_{i}}$$
wherein wᵢ represents weights corresponding to nearest i calculation points, calculation of the weights being expressed as:
$${w}_{i} = \frac{1}{{d}_{i}}$$
wherein dᵢ represents a distance from an i-th nearest calculation point to the new calculation point;
converting the initial rotation vector
$${\vec{t}}_{r 1}^{0}$$
to an initial rotation matrix
$${m}_{r 1}^{0} .$$

5. The method according to claim 1, wherein the S5 includes:
converting an initial rotation vector
$${\vec{t}}_{r 1}^{0}$$
to an initial rotation matrix
$${m}_{r 1}^{0} ,$$
and rotating and translating a point cloud block A corresponding to a new calculation point to a new position A*,
$${A}^{*} = {m}_{r 1}^{0} \times A + {\vec{t}}_{1}^{0}$$
performing re-registration on the point cloud block A using the average domain vector algorithm to obtain a new transformation matrix M₂, interpreting the new transformation matrix M₂ to obtain a new translation vector and a new rotation matrix, and superimposing the translation vector and the rotation matrix to obtain a current total deformation amount.

6. The method according to claim 1, wherein the S6 further includes:
in each iteration of executing the S4 and S5, determining the maximum correspondence point search distance, the minimum point cloud search radius, and the point count threshold of point cloud to be used in a next iteration based on a point cloud local density, a regional slope, and a regional roughness of the current iteration.

7. The method according to claim 6, further comprising:
adjusting the maximum correspondence point search distance, the minimum point cloud search radius, and the point count threshold of point cloud based on effective registration results of a previous iteration.

8. The method according to claim 6, further comprising:
before executing the S4 in each iteration, obtaining an average displacement of the calculation points in a plurality of monitoring regions; and in response to the average displacement of the calculation points being less than a change threshold, using the previous calculation points in the plurality of monitoring regions.

9. The method according to claim 1, further comprising:
determining a plurality of deformation rate distributions based on a plurality of historical displacement and deformation fields at each preset period; determine a local deformation rate of a plurality of monitoring regions based on the plurality of deformation rate distributions; in response to the local deformation rate satisfying a scheduling condition, generating a scheduling instruction based on the local deformation rate and sending the scheduling instruction to a surface monitoring device or an inspection unmanned aerial vehicle (UAV); the surface monitoring device scanning the plurality of monitoring regions and collecting data based on the scheduling instruction; the inspection UAV performing a re-scan on the plurality of monitoring regions based on the scheduling instruction.

10. The method according to claim 9, further comprising:
determining a plurality of potential instability regions based on the local deformation rate; determining a cumulative displacement of each potential instability region based on the historical displacement and deformation fields; in response to a determination that the cumulative displacement is greater than or equal to an early warning threshold, sending a control instruction to a monitoring terminal, and the monitoring terminal activating an audible and visual alarm device to issue an alarm or activating a remote transmission device to send alarm information based on the control instruction.

11. A system for non-contact monitoring of three-dimensional global landslide deformation with millimeter-level accuracy, wherein the system is applied to the method according to claim 1, and the system comprises:
a point cloud data acquisition and feature extraction module configured to acquire the two phases of three-dimensional surface deformation point cloud data for deformation interpretation and extract the global point cloud features;
a parameter optimization module configured to perform optimization based on the global point cloud features and the trained neural network model using the Bayesian optimization algorithm to obtain the optimal initial calculation point spacing, the minimum point cloud search radius, the maximum correspondence point search distance, the point count threshold of point cloud, and the RMSE threshold,
an initial calculation and registration module configured to obtain the optimal initial calculation points based on the initial calculation point spacing, divide to obtain the initial point cloud blocks, perform preliminary registration using the average domain vector algorithm to obtain the initial transformation matrix, and decompose the initial transformation matrix to obtain the translation vector and the rotation matrix;
a calculation point refinement and weighted average module configured to reduce the calculation point spacing to obtain the new calculation points, and perform weighted averaging on the rotation vector and the translation vector of previous calculation points adjacent to the new calculation points using inverse distance weighting (IDW) to obtain the initial transformation parameters of the new calculation points;
a point cloud block transformation and re-registration module configured to rotate and translate the initial point cloud blocks to new positions based on the initial transformation parameters of the new calculation points, perform re-registration to obtain the new transformation matrix, and decompose the new transformation matrix to obtain the new translation vector and the new rotation matrix;
a convergence determination and calculation control module, wherein when the displacement of the current calculation point after certain registration is less than the specified threshold, assuming that the current calculation point spacing is d, calculation is determined as completed when the displacement of the current calculation point is within a range of d/2, and when reducing the calculation point spacing next time, the region where the calculation point is located does not take the new calculation points but directly uses the previous calculation points; and when the calculation point spacing is reduced to the specified threshold, calculation is determined as completed after the current calculation ends;
a final deformation calculation module configured to interpret to obtain the translation vector corresponding to the calculation points based on all the calculation points and the corresponding transformation matrices in final calculation, superimpose the translation vectors with the initial translation vectors of the current calculation to obtain the total translation vectors of the calculation points; and obtain the global displacement deformation field of the calculation region.

12. A computer device, comprising a memory, a processor, and computer programs stored on the memory and executable on the processor, wherein when executing the programs, the processor implements the method for non-contact monitoring of three-dimensional global landslide deformation with millimeter-level accuracy according to claim 1.

13. A non-transitory computer-readable storage medium, comprising computer programs that, when executed by the processor, direct the processor to implement the method for non-contact monitoring of three-dimensional global landslide deformation with millimeter-level accuracy according to claim 1.
